(19) United States
(12) Patent Application Publication
(10) Pub. No.: US 2026/0111854 A1
(43) Pub. Date: Apr. 23, 2026

(54) BUSINESS METHOD AND SPENT GLYCOL TREATMENT FACILITY FOR SERVICING A GROUP OF AIRPORTS AND AIRLINES AND PROVIDING COST AND ENVIRONMENTAL BENEFITS

(71) Applicant: 12292939 Canada Inc., Dorval (CA)

(72) Inventors: Gabriel Lépine, Beaconsfield (CA); Mark Vilcek, Kirkland (CA)

(73) Assignee: 12292939 Canada Inc., Dorval (CA)

(21) Appl. No.: 18/921,065

(22) Filed: Oct. 21, 2024

(51) Int. Cl. G06Q 10/30

(52) U.S. Cl. CPC G06Q 10/30

(57) ABSTRACT

A business method, in combination with a high efficiency spent glycol fluid treatment facility, provides financial benefits to airlines and additional benefits to several associate airports while reducing environmental pollution. The spent glycol servicing facility is equipped with a high efficiency spent glycol treatment system which recovers glycol from the spent glycol solutions collected from the tarmacs of the several airports. The treatment system is capable of recovering glycol from the spent solutions down to a concentration of about 0.25%. The business method provides a cost reduction in the sale of the recovered glycol and further cost savings to airports by doing aways, or substantially reducing, the transport of spent glycol fluid solutions to water treatment centers where there is no benefit to the airlines using those airports. The method also permits considerable cost reductions to the airports relating to the storing of recovered spent glycol solutions from the tarmacs. The method also benefits the environment by the reduction of air and ground pollution, as well as the use of recovered grey water and heat, and still further provides security to the airports and airlines by ensuring adequate supply of certified aircraft de-icing glycol during their entire aircraft de-icing period.

### FIELD OF THE INVENTION

The present invention relates to a business method including a high efficiency system for treating spent glycol solutions recovered from airport tarmacs of a group of airports to recover substantially virgin glycol therefrom for the resale to the group of airports and further wherein the business method provides cost reductions to airports and airlines as well as providing environmental benefits.

### BACKGROUND OF THE INVENTION

Ice and snow accumulation on the wings of aircrafts is a known hazard which distorts the shape of the airfoil and thereby reducing the lift needed for controlled flight. It also increases the weight of the aircraft and thereby impeding flight. It is therefore necessary to remove ice and snow from the aircrafts prior to flight and this is accomplished by the application of certified glycol aircraft de-icing fluid mixture which is sprayed onto the aircrafts by specialized vehicles constructed for such de-icing operations. Such de-Icing is usually carried out at designated de-icing pad areas not too far to the runways of airports but with small regional airports it could be carried out anywhere on the tarmac.

After the application of the de-icing glycol solution, there is an accumulation of spent glycol solutions on the surface of the tarmac and in some instances, such as with international airport in particular, local recovery and processing facilities are installed at designated de-icing pads to automatically recover and recycle the spent glycol solution. However, to small regional airport this spent glycol solution on tarmac areas Is considered as waste material which is a burden to the airports and pollutes the environment. Small regional airports do not have the means to recover and recycle their spent glycol solutions effectively and therefore such must be recovered by specialized service establishments having equipment capable of removing such spent glycol solutions and to transport it by tanker vehicles to wastewater treatment centers. Several transport trips are made each winter season to such treatment centers. This results in additional costs to such small regional airports or airlines, particularly during vigorous winter months and prolong cold periods of time when aircrafts de-icing needs are frequent. Improper recovery and storage methods also causes environmental pollution and waste. The CO2 emission of the transport tanker vehicles, which may have to travel frequently and sometimes long distances to a treatment center, also pollutes the air.

In order to reduce such costs and air pollution, some regional airports have invested in equipment to recover such spent glycol solutions from their tarmac surfaces and store it in a dedicated reservoir(s) of sufficient size to collect and accumulate spent glycol over a great part of the winter season until the reservoir(s) reaches a capacity where there becomes a need to have it transported to a wastewater treatment center. These reservoirs may be formed by constructing large open pit lagoons in the ground which are lined with a geotextile membrane impervious to liquid. Such a storage practice often results in contamination to the soil by overflow, particularly during heavy rain or snow fall, and further causes air pollution by evaporation. The use of wastewater treatment centers is also expensive for several reasons, including the need to purchase new supplies of de-icing certified glycol for containment in a dedicated aircraft de-icing supply tank(s) to ensure adequate reserves. Therefore, regional airports are obliged to have storage tanks to store glycol de-icing solutions during winter months and in sufficient quantity to ensure adequate space availability. However, often this storage may not be sufficient when unexpected bad winter conditions prevail for long periods of time. Also, the spent glycol storge tanks and/or open pit lagoons become overburdened due to heavy wet snowfalls and rain which produce large amounts of water in the collected spent glycol fluid solution further diluting the glycol contained therein. To reduce the cost of recovery and transportation, many airports, particularly smaller regional airports, collect spent glycol shortly after de-icing an aircraft and in the immediate zone where the aircraft was de-iced whereby to recover a spent solution which contains at least a concentration of 10% or more. Therefore, the volume of spent solution fluid sent to treatment centers is greatly reduced costing less. The remaining uncollected spent solutions containing less glycol is plowed away by the airport to the sides of the tarmac and some of the liquid will seep into the public sewer system or into the soil while some will evaporate. This results in land and air pollution and becomes a problem to the airports, due to government regulations which need to be abided by and the public health.

There is therefore a need to overcome these problems faced by airports to ensure their needs for the removal of spent glycol solutions from their de-icing operations while ensuring that they have adequate storage facilities for the storage of glycol aircraft de-icing solutions. It would be advantageous if the spent glycol removed from their tarmac could be recovered and treated to produce certified aircraft de-icing solutions which could be reused at reduced cost.

There is also a need to have a reliable and continuous supply of certified glycol aircraft de-icing solution during winter months and at reduce cost to the airlines which use these air airports during these cold winter months.

There is also a need to provide a business method including a glycol treatment and recovery facility capable of servicing, not only one major airport where its facility is located, but as well, a group of smaller regional airports within a large serviceable geographical area to the spent glycol treatment and recovery facility and which has adequate storage tanks to receive and store the spent glycol solutions from the regional airports, treat their solution to remove the glycol therefrom to produce a glycol of a purity of 99.5% or more and ensure the major and regional airports that there is an adequate supply of substantially virgin glycol aircraft certified de-icing solutions in the airports storage tanks to suit the needs of all airlines using their airport during the cold winter period.

There is also a further need to have an improved spent glycol treatment facility capable of recovering substantially all of the glycol contained in the spent glycol solution in which the glycol concentration is as low as 0.25% concentration and in the process recover heat form the equipment of the process and recover the grey water from the evaporation and distilling equipment for re-use and thereby providing a further benefit to the airport where the servicing facility is located and further benefiting the environment by the reduction of air and land pollution caused by the storage and recovery of spent solutions from the tarmacs of the airports associated with the servicing facility.

There is also a further need to have a spent glycol treatment facility to permit airports to substantially decrease or eliminate the use of offsite water treatment centers, better manage or do away with retention ponds which contaminate the soil and air, and provide for a self-sufficient and reliable supply chain, and providing cost reductions to airport and airlines relating to the de-icing of their aircrafts, while also providing added security by insuring adequate storage tank space for the recovery of spent glycol solutions collected from the tarmac of the airport and adequate reserve of aircraft certified de-icing glycol solution.

### SUMMARY OF THE INVENTION

It is a feature of the present invention to provide a business method and a high efficiency glycol recovery facility and system capable of providing all of the above-mentioned needs.

A further feature of the present invention to provide a business method and a high efficiency facility for treating spent aircraft glycol de-icing solutions recovered form airport tarmacs and capable of the recovery of glycol down to a low glycol concentration of down to 0.25% whereby the recovered water is suitable for reuse in grey water system applications.

Another feature of the present invention is to provide a business method including a high efficiency glycol treatment facility located at a major airport which is utilized as a hub treatment facility having sufficient storage tank capacity for the storage of recovered spent glycol liquid solutions from an additional group of airports for treatment of their spent glycol solutions and wherein such facility has storage capacity to store substantially virgin glycol of a concentration of at least 99.5% for re-use by all airports associated therewith to ensure an adequate and reliable supply of recovered, substantially virgin certified de-icing glycol and in the process providing a financial benefit to the airports and airlines using such airports as well as benefiting the environment by the reduction of air and land pollution.

A further feature of the present invention is to provide a closed-loop spent glycol treatment system housed in a closed building and wherein heat generated by the treatment system is recovered and re-used into the closed building for heating and thereby reducing heating costs to the building during cold weather months and further wherein water extracted from the evaporators and distiller is recovered for grey water applications to the building and a major airport at which the treatment system is located and further wherein any excess heat can be supplied to the airport resulting in cost savings.

A still further feature of the present invention is to provide a business method including a high efficiency spent glycol treatment facility, associated with a group of regional airports within a large service area to the facility, and which can provide security to the group of airports by not having to rely on glycol de-icing fluid suppliers located far away from the group of airports, where travel for delivery can be unpredictable during winter months for the delivery of this crucial fluid to suit their needs when it becomes imperative to de-ice aircrafts for their safety and that of their passengers.

A further feature of the present invention is to provide a business method including a high efficiency spent glycol treatment facility associated with a major airport and a group of regional airports within a large service area to the facility and which is capable of storing all of the recovered spent glycol solutions from the associated major airport an the group of regional airports for the treatment and recovery of substantially virgin glycol from their spent glycol de-icing solutions for resupply with recovered certified aircraft Type 1 de-icing solutions and thereby ensuring sufficient supply in their storage tanks during prolong cold winter periods

A further feature of the present invention is to provide a business method including a high efficiency spent glycol treatment facility capable of operating 24/7 and remotely controlled and having sufficient storage capacity or collected spent glycol solutions from a major airport where the installation is operational as well as from a group of airports affiliated therewith, some of which have storage tanks or outdoor open storage lagoons for the storage of their collected spent propylene glycol solutions and further wherein the service facility transfers know-how to these airports to improve the quality of their recovered spent glycol solutions for financial benefits and improve storage methods to reduce air and ground pollution that may be caused by their method of operation.

Another feature of the present invention is to provide a business method including a high efficiency spent glycol treatment facility associated with a group of airports within a service area and which facility is operated on a continuous basis by having a computerized controller with a program software permitting remote monitoring and trouble shooting of its operation on a continuous 24/7 basis as well as a communication link to the group of associated airports to provide individual storage data relating to their recovered spent glycol solutions and other business transactions related thereto.

Summarizing the above noted features of the present invention there is provided a business method including a high efficiency spent glycol treatment facility which, in association with a major airport and a group of affiliated regional airports, provides for a decrease or elimination of the use of offsite waste water treatment centers to dispense of its spent glycol solutions, improve or remove the retention ponds which contaminate the air and soil, provides to all of the airports a self-sufficient and reliable supply chain for aircraft certified de-icing glycol solution and a cost reduction to the airlines using such airports, provides benefits to the environment by CO2 emission reduction, provides further cost reduction for the regional airports by improved removal of spent glycol from their tarmacs and the use of recovered of heat and water generated by the spent glycol treatment process, and further provides the regional airports with added security by insuring adequate regional storage tank space for their local storage of recovered spent glycol solutions from their tarmacs and the insurance of the supply of certified aircraft de-icing glycol solution to their de-icing certified glycol solution storage tank.

According to the above features, from a broad aspect, the present invention provides a business method including a spent glycol fluid treatment system to recover glycol from spent aircraft de-icing and providing financial benefits to airlines and several other benefits to airports of different sizes and in the process reducing environmental pollution and waste. The method comprises the steps of (a) providing a spent glycol servicing facility at a major airport. The servicing facility has a treatment system for the treatment of spent glycol fluid solutions recovered from the tarmac of the major airport and stored in a storage feed tank having sufficient capacity to store spent glycol fluid solutions collected during cold wintertime. A regional storage tank is provided to store spent glycol solutions collected from a group of regional airports associated with the servicing facility for storing their glycol from their spent glycol solutions recovered from their tarmacs. The servicing facility further has one or more supply storage tanks for the storage of substantially virgin glycol recovered by the spent glycol treatment system to supply the needs of the major airport as well as the group of regional airports. Accordingly, there is provided to the major airport and the regional group of airports a cost reduction by discontinuing or reducing the transport of their spent glycol fluid solutions to water treatment facilities where there is no return benefit to them for the glycol contained in their spent glycol solutions The method also provides a reliable supply of aircraft de-icing glycol fluid solution for the cold winter period de-icing operations and at reduced cost due to the recycling and recovery of substantially virgin glycol from their collected spent glycol solutions and a further cost saving to the airlines having their aircrafts de-iced by aircraft de-icing solution containing recovered glycol. The method further results in a benefit to the environment by the reduction of air and ground pollution.

According to a further broad aspect of the present invention there is provided a high efficiency spent glycol treatment method, associated with a business method and a spent glycol servicing facility equipped with a spent glycol fluid treatment system which provides cost benefits to airports and airlines and reduces environmental pollution and waste. The method comprising the steps of:
i) storing in a storage feed tank of the spent glycol fluid treatment system, spent glycol de-icing solutions recovered from the tarmac of a major airport at which the spent glycol servicing facility is operational,
ii) storing in a regional storage tank of the spent glycol fluid treatment system, spent glycol solutions received from a group of airports located in a servicing geographical area to the spent glycol servicing facility,
iii) feeding the spent glycol aircraft de-icing solution from the storage feed tank to a low-concentration evaporator which refines the spent glycol solution by evaporating water to elevate the glycol concentration of from about 0.25% to about 10% glycol concentration,
iv) feeding the spent glycol solution having a glycol concentration of about 10% glycol concentration to the regional storage tank,
v) filtering the spent glycol solution having a glycol concentration of about 10% glycol concentration to remove thickeners and residues,
vi) feeding the filtered spent glycol solution having a glycol concentration of about 10% glycol concentration to a further evaporator to further remove water from the spent glycol solution having a glycol concentration of about 10% glycol concentration to bring the glycol therein to a concentration of substantially 50% glycol,
vii) feeding the glycol of a concentration of substantially 50% glycol to a distiller wherein the remaining water therein is separated from the glycol to produce substantially virgin glycol of a concentration of 99.5%, and
viii) storing the substantially virgin glycol of a concentration of 99.5% in a supply storage tank for further use in producing aircraft de-icing glycol fluid solutions.

According to a still further broad aspect of the present Invention there is provided a spent glycol treatment system for the recovery of glycol from spent glycol solutions recovered from the tarmac of a major airport at which the treatment system is installed. The spent glycol treatment system has a storage feed tank in which is stored spent glycol recovered from the tarmac of the major airport. A regional storage tank is provided in which is stored spent glycol solutions of about 10% glycol concentration received from a group of regional airports. A low-concentration evaporator refines the spent glycol solutions contained in the storage feed tank of the major airport to elevate the glycol concentration of from about 0.25% to about 10% glycol concentration for mixing with the spent glycol solutions collected in the regional storage tank. A filtration stage filters the spent glycol solution having a glycol concentration of about 10% glycol concentration to remove thickeners and residues therein. A further evaporator removes water from the filtered liquid having a glycol concentration of about 10% to further remove water to bring the glycol to a concentration of substantially 50% in the remaining liquid. A distiller then separates the 50% water in the remaining liquid to produce glycol having a concentration of substantially 99.5%. One or more supply storage tanks are provided to store the glycol having a concentration of substantially 99.5%.

### DESCRIPTION OF THE DRAWINGS

A preferred embodiment of the present invention will now be described with reference to the examples thereof illustrated by the accompanying drawings in which:

FIG. 1 is a block diagram of the business method including a glycol treatment servicing facility and which provides financial benefits to airports and airlines and in the process reduces environmental pollution.

FIG. 2 is a schematic diagram illustrating the functional stages in the spent glycol treatment process associated with the business method of the present invention for the recovery of glycol in the spent glycol solutions recovered from de-icing pads of airports; and

FIG. 3 is a block diagram, illustrating in more details the high efficiency spent glycol treatment system forming part of the present invention.

### DESCRIPTION OF THE PREFERRED EMBODIMENT OF THE INVENTION

Before any embodiments of the application are explained in detail, it is to be understood that the application is not limited to the details of construction and the arrangement of component part set forth in the following description or illustrated by the accompanying drawings. Further, it is to be understood that the phraseology and terminology used herein is for the purpose of description and should not be regarded as limiting but should encompass equivalents thereof. When referring to the term “glycol” in the description, it is intended to refer to “propylene glycol” as used in Type 1 certified aircraft de-icing solutions which conform to AMS 1424 Standards.

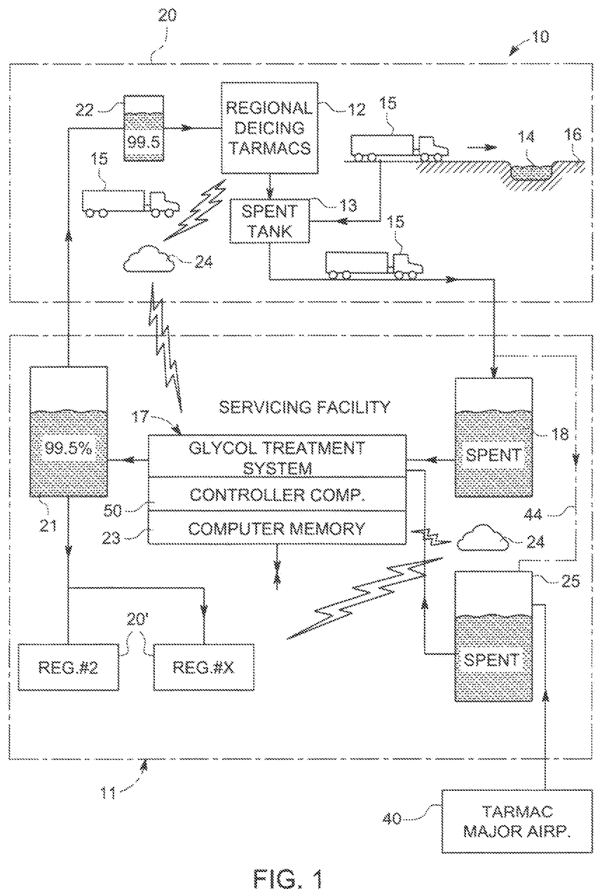

Referring now to the drawings, and more specifically to FIG. 1, there is illustrated generally at 10 the business method of the present invention and the spent glycol treatment servicing facility 11 associated therewith. The purpose of the business method is to provide cost savings to a major airport and a group of regional airports associated airport and airlines using those airports, and relating to aircraft de-icing during cold winter months, and in the process achieve a reduction in air and ground environmental pollution. The method consists of constructing a spent glycol recycling facility to service a major airport and a group of regional airports, of different sizes, to recycle their spent glycol solutions collected on the surface of their tarmacs 12 to recover the glycol therein. When spraying aircraft with certified de-icing glycol solution during cold weather conditions, spent glycol solution accumulates on the surface of the tarmac under the aircraft. This solution of spent glycol solutions contains glycol, water, ice, aircraft fuel, melting snow and other impurities. If that de-icing glycol solution is not removed shortly after de-icing, the spent solution will be diluted with more snow or rain and spread on the tarmac. The spent glycol solutions sitting on the tarmac will eventually be plowed or blown away to the surrounding areas of the tarmac by snow removal equipment of the airport. Therefore, it is imperative to have the spent glycol removed as quickly as possible in order to recover glycol from the spent glycol de-icing solution when the glycol is at its highest concentration. Preferably, the recovered spent glycol solution should have at least 10% glycol concentration and higher, before it gets diluted by further snow and rain and displaced to the surrounding ground area where it eventually seeps into the ground causing pollution. Leaving the spent glycol solution on the tarmac will also cause the chemicals in the solution to evaporate into the atmosphere when heated by the sun. It is therefore to the benefit of the airports to be equipped with the proper equipment to recover the spent glycol de-icing solution quickly from their tarmac after de-icing aircrafts and to store it to their storage reservoirs.

At some international airports where aircraft de-icing facilities are provided, this process of recovery is made automatically by having designated de-icing pad areas equipped with a recovery sewer system having underground conduits which channels the spent glycol fluids from the de-icing pads to a processing glycol recovery system located in a dedicated building close by. Such a system is for example described in our related U.S. Pat. No. 10,513,481, issued Dec. 14, 2019, and operational at the Montreal Trudeau International Airport in Canada. However, small regional airports, which may have only one or two people to look after the task of de-icing aircrafts, do not have the financial means nor all the latest equipment to recover and recycle their spent glycol solutions. Therefore, some of these small airports may resort to leaving the spent solution on the tarmac until it dilutes with the snow and rain and then swept away to surrounding ground area or into the city/county sewer system.

As illustrated in FIG. 1, most regional airports, which are more concerned with the environment and government regulations, will invest in one or more storage tanks 13 and/or open pit lagoon 14 as well as one or more GRV vehicles (ground recovery vehicles), not shown, and which are equipped with vacuum systems and holding tanks to recover their spent glycol mixed with water and other impurities for transport to their storage tanks 13 or open pit lagoons 14. However, because the spent glycol solutions recovered from the tarmac contains a very large percentage of water, in order to reduce the transportation cost when later shipping to the wastewater treatment centers, the airport personnel designated with this task will only recover the spent solutions in the immediate area where aircrafts are de-iced where the glycol content is at its highest purity, usually between 10% to 30%, for local storage and the remaining spent solution is discarded to the sewer system or the surrounding ground area.

When the spent glycol storage tanks 13 and/or lagoon 14 reach a certain volume or level, it is then necessary to have its contents, or part thereof, transported to the wastewater treatment center. Some small regional airports have been known to have dumped the spent glycol solutions directly into the public sewer system thereby polluting water in rivers. Needless to say, these open pit lagoons 14 are not ideal storage facilities as they require valuable land space and expensive containment linings and maintenance to prevent seepage of the polluting spent glycol liquid into the surrounding soil 16′. Also, being opened to the atmosphere, rain and snow accumulates in the open pit lagoons increasing the volume of water into the spent glycol solutions diluting the glycol content and spilling some of the surface content over the edges of the lagoon. Further, biological degradation of the waste material and evaporation creates an air environmental pollution problem. The transportation of the spent glycol to wastewater treatment centers by tanker trucks also results in CO2 emissions which pollute air. Because of the large volume of water in the recovered spent glycol solution, it is important to have reservoirs which are large enough to always have available space to minimize on the number of trips to the wastewater r treatment center which is costly. If their reservoir fills up too quickly the airport de-icing personnel will sometimes have to dump some of the stored spent glycol solution into the public sewage system or surrounding ground areas causing contamination.

The business method of the present invention equipped with its spent glycol servicing facility 11 which to overcome the above mentioned problems by inspecting the airports associated therewith to review their method of handling and storage of spent glycol solutions and transfer their know-how to improve their method to recover and store spent glycol de-icing solutions and, in the process, resulting in cost benefits and reduction in air and ground pollution. Open pit lagoons, for example, can be covered with an inflatable or rigid membrane to shelter the lagoon from rain and snow to prevent overflow and evaporation. The spent glycol fluid recovery service facility 11 makes it possible for the airports to have their de-icing glycol recovered from their spent solution and reused at a lower cost and as well being able to manage their storage space for their collected spent glycol solutions by ensuring available storage volume space at the servicing facility due to the continuous operational treatment process at the service facility at their disposal. It is conceivable that some of the airports may want to do away with open pit lagoons, and by doing so, reclaim land space and reduce environmental pollution. They would replace the lagoon with a storage tank requiring less volume space, the contents of which could be delivered periodically to the servicing facility where storage space is always available.

The spent glycol treatment system 17 is provided with a treatment system where additives are introduced and mixed with the recovered glycol of substantially 99.5% purity to produce certified glycol solutions for aircraft de-icing, such as described in our aforementioned US patent. The system 10 is preferably, although not exclusively, associated with a major airport, usually an international airport where there is sufficient air traffic to support its cost of operation. However, to be able to service an additional group of regional airports 20, 20′in association therewith, to provide the benefits mentioned herein above, it is necessary to have sufficient spent glycol storage tank(s) capacity in the millions of gallons. Also, the recycling system needs to be operational on a continuous basis, as long as there is spent glycol solutions in its spent glycol storage tank(s) 18 where the spent glycol solutions of all associated airports is collected whereby to be able to supply certified aircraft de-icing glycol solutions to all of its associated airports. The spent glycol solutions collected by the regional airports will In most cases have a glycol concentration of at least 10% to 30% glycol to be more profitable.

The business method of the present invention provides the necessary processing and storage equipment to service the needs of all of its associated airports as well as projecting for future expansion needs to ensure adequate storage space for everyone's collected spent glycol solutions. The system of the present invention also has a computer system provided with a programmable memory in which can be stored operational and managing software to effect all of the various automated tasks of the continuously operating system, such as monitoring the percentage glycol concentration of the spent solutions delivered by each of its associated airports, the volumes of spent glycol delivered by the associated airports to the storage tank(s) 18, the volume of recycled aircraft de-icing solutions stored in the supply storage tank 21, as well as the storage requirements in the spent glycol holding tanks 13 of each regional airport 20, 20′, delivery volumes of certified glycol, delivery costs, retrieval costs if this service is requested, and all financial information with each of the groups of regional airports and the major airport to be serviced, etc. With this system at their disposal, the regional airports 20, 20′can reduce their local storage needs for their collected spent glycol fluid solutions by their periodic delivery to the servicing facility storage tank 18 resulting in continuous storage tank storage space and do away with using the treatment centers where there are no benefits but only extra costs. Therefore, the servicing facility provides to the regional airports, as well as the major airport, a cost reduction by discontinuing the transport of their spent glycol fluid solutions to wastewater treatment centers and better service in the removal of spent glycol solutions from their tarmac. It has been estimated that a small international airport with about 50 to 60 flights a day, the spent glycol servicing facility of the present invention would have a production capacity of up to 550,000 gallons of AMS 1424 Type 1 certified propylene glycol de-icing solution. It is also estimated that the system could reduce CO2 emissions by 16.5 million lbs. Also, 5.7 million gallons of water previously sent offsite for treatment can now be reused at the airport for gray water purposes and resulting in a reduction of waste of potable water from the public system. The treatment system would also be capable of recovering the heat loss generated by the equipment of the treatment system.

The business method of the present invention can also offer a reliable monitoring and transport service for the monitoring and removal of spent glycol fluid solutions from the spent glycol storage tanks 13 of the group of regional airports 20, 20′ to assure them continuous capacity in their storage tanks for the storage of recovered spent glycol solution. It can also monitor and supply certified de-icing glycol fluid solution to their supply tanks 22 to maintain sufficient predetermined quantities during winter months de-icing operations. The business method also provides security to the airports and airlines by ensuring the availability of sufficient certified glycol in their supply tank(s) 22, as well as sufficient space in their spent glycol storage tank(s) 19 during bad winter periods due to their close proximity to all of its associated airports to be serviced. This is particularly so if the former de-icing glycol suppliers had to travel long distances during bad winter road conditions or if the manufacture ran out of glycol aircraft de-icing solutions.

As mentioned above, because the treatment system of the present invention is capable of storing large quantities of recovered spent glycol in its storage tank(s) 18 and 25, treating it to recover substantially virgin glycol therefrom on a continuous basis, and storing it in supply tank(s) 21, it ensures adequate capacity to all of its associate group of airports for the continuous recovery of spent glycol from their tarmac as well as having a sufficient storage supply of aircraft certified de-icing glycol solutions in its storage tank(s) 22 to be able to supply them during unpredictable prolonged bad winter weather conditions. The substantially virgin glycol in the storage supply tank(s) 21 can also be blended with additives to produce certified glycol for supply in quantities commensurate with their individual needs, such blending equipment being described in our above-mentioned US patent. Most associated regional airports 20, 20′will require recovered glycol already blended to certification while a few regional airports may prefer to do their own blending and therefore unblended glycol is made available to them. All these variables are inputted in the computer memory 23 of the controller computer 50 of the servicing facility 11 which has been programed to deal with such. Also, all the associated airports are in communication with the servicing facility 11 through an internet link 24 as well as telephone communication link providing additional safety.

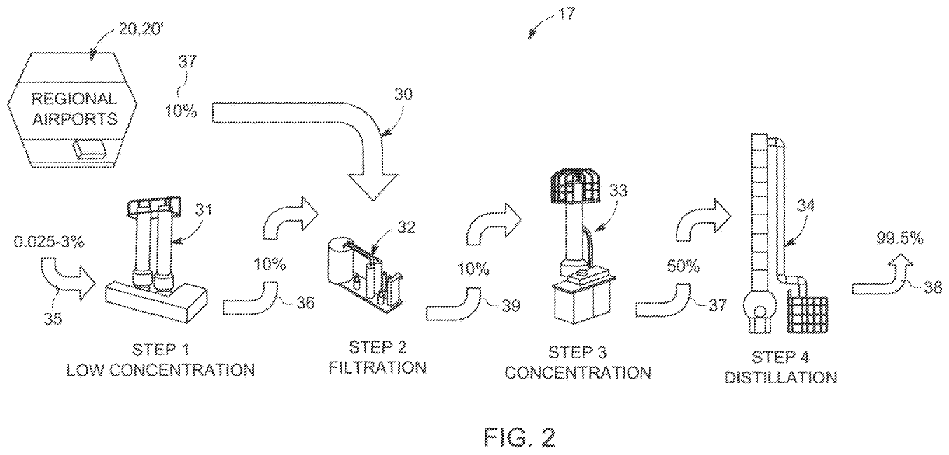

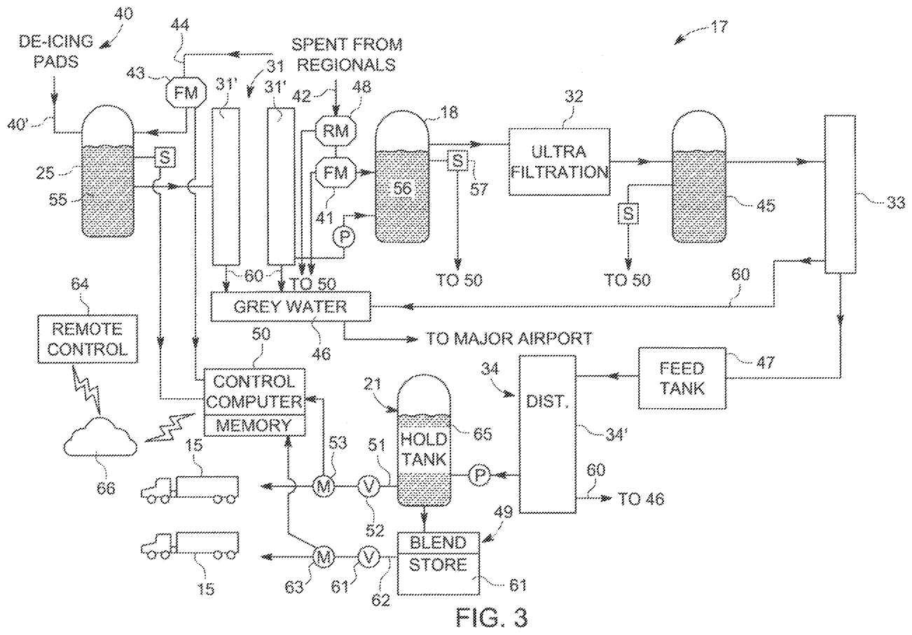

Referring now to FIGS. 2 and 3, they illustrate the improved spent glycol treatment system of the present invention to service several airports on a continuous basis. They illustrate the fluid treatment stages and associated equipment of the treatment system 17, to recover substantially virgin glycol from spent solutions in their storage tank 18, 25. Storage tank 25 contains spent glycol solutions having a glycol concentration of only about 0.25% recovered from the major airport, and storage tank 18 contains spent glycol solutions of at least 10% glycol concentration recovered from the regional airports 20, 20′. In the patented system referred to above, the spent glycol solution below a concentration of 5% was not treated and sent to the sewer system. In the patented process the spent glycol was firstly directed through filtration stages including ceramic filters to recover very fine solid particles and there was also a need to recycle the filtered liquid back through the filtration equipment. The filters also needed to be cleaned on a periodic basis in order not to clog and such caused many interruptions in the treatment system. The improved system 17 of the present invention has the capability of recovering glycol from its associated major airport having a spent glycol solutions down to 0.25 glycol concentration. By doing so other environmental benefits are achieved as mentioned herein.

FIG. 2 illustrates the basic method steps of the spent glycol treatment system 17 of the present invention associated with a small international airport, as mentioned above. They consist of feeding, as indicted by arrow 30, the regional airports collected solutions of at least 10% spent glycol 37 present in the storage tank(s) 18, to an ultra-filtration stage 32 capable of processing 25,000 galloons of fluid per day and upon reaching a 10% glycol to water ratio, the remaining stormwater is filtered to remove any foreign contaminants like long-chain polymers and jet fuel. On the other hand, the collected spent glycol solution 35 in the storage feed tank 25 of the international airport, which contains a low concentration of glycol, is fed to a low glycol content evaporator stage 31 which refines the collected spent glycol solution by utilizing mechanical vapor compression to produce an outflow containing about 10% glycol to water ratio. The 10% glycol solution 36 is then fed to the regional storage tank 18, not shown in this figure, where it mixes with the at least 10% solution from the regional airports and fed to an ultra-filtration stage 32, as mentioned above, to remove thickeners and residues from oil and fuel that may have been collected from the aircrafts when being de-iced. The 10% filtered solution 39 is then fed to a second evaporator stage 33 where the 10% water content in the filtered solution 39 is evaporated to bring the solution to a 50% glycol concentration solution 37. The liquid solution 37 is then introduced into a distillation tower 34 where the remaining water is separated out of the solution to produce substantially virgin glycol 38 of a purity of 99.5% or better and stored in the supply tank 21, as shown in FIG. 1, to be blended with proprietary additives to produce certified Type I glycol that conforms to AMS 1424 standards for aircraft de-icing. The glycol in the supply tank 21 can also be fed to supply tanks of some of the regional airports which do their own blending to produce certified aircraft de-icing solutions.

FIG. 3 is a block diagram illustrating the main stages of FIG. 2 with more details of the present spent glycol treatment method and system to cater to a major airport as well as a group of regional airports to recycle their spent glycol and thereby achieve cost benefits as well as a reduction in air and ground pollution. As described above with reference to FIG. 1, the spent glycol treatment system 11 is equipped with two distinct storage tanks, namely a storage feed tank 25 in which is stored spent glycol recovered from the de-icing pads 40 of the major airport is delivered by underground conduits 40′, and a regional storage tank(s) 18 in which spent glycol for the associated regional airports is stored. The spent glycol 56 recovered in the feed storage tank 25 contains spent glycol fluid solutions 55 of as low as 0.25% glycol concentration so there is a large amount of water in the recovered glycol solution. However, with the group of regional airports it is to their benefit to deliver spent glycol fluid solutions in which the glycol concentration is higher than at least 10% concentration. The reason for this is that the business method requires at least this low concentration to be more financially beneficial to the regional airports and airlines using those airports.

The resale cost of the recovered glycol delivered from each of the regional airports is determined taking to account the quality of the delivered glycol. In order to control this requirement, it is essential that the servicing facility measures, by the use of a refractometer meter 48, the glycol concentration before it is introduced in the regional storage tank 18 by each of the regional airports. If the concentration is found to be below the 10% requirement, then that spent glycol solution is delivered to the inlet port 44 of storage feed tank 25. Also, included in the calculations of the resale cost of the aircraft de-icing glycol solution is the volume of the delivered spent glycol from each of the regional airports and this is done by a flow meter 41 provided at the inlet port 42 of the regional storage tank 18 and a further flow meter 43 mounted at the inlet port 44 of the storage feed tank 25 and provides signals indicative of the volume in the tank to the computer 50. The glycol concentration measured indicates the amount of water to be extracted and the volume the amount of liquid to be processed. All this information is inputted into the computer 50 together with the regional airport's identification code for processing and storage.

The collected spent glycol solution in the storage feed tank 25 is pumped to a content evaporators 31′ at the evaporator stage 31 using falling film technology to raise the glycol concentration to 10% from its original concentration of as low as 0.25%. The 10% glycol concentration solution is then pumped to the regional storage tank 18 where it mixes with the spent glycol 56 of at least 10% glycol concentration delivered from the regional airports 20, 20′. A fluid level sensor 57 is provided to measure the volume of the spent solution in the tank 18 and sends measurement signals to the controller computer 50. Thereafter, the spent glycol solution from the regional storage tank 18 is subjected to crossflow filtration at the filtration stage 32 where solids are removed to minimize scaling in the equipment, and which would hinder the heat transfer of the evaporation process. The filtered spent glycol solution is then fed to a buffer tank 45 which is a holding tank which feeds batches of the stored fluid to the second evaporator stage 33 provided to raise the glycol concentration of the fluid to 50%.

As mentioned above, the treatment system 17 also recovers waste water for grey water applications and this is done by channeling the extracted water from the evaporator stages 31 and 33 and the distiller stage 34 feeding it into one or more collecting reservoirs 46 by conduits 60 and which reservoirs 46 may be housed within the building of the glycol servicing facility for their use and as well pumped to reservoirs, not illustrated, of the major airport for their use. The 50% fluid from the evaporator stage 33 is pumped to a feed tank 47 which is essentially a holding tank to collect fluid solution which is pumped in batch contents to a distiller 34′ at the distillation stage 34 where the remaining water is removed and sent to the waste water reservoir 46 and the glycol, herein the propylene glycol of a purity of 99.6%, is further directed to holding tank(s) 21 to later be fed to blending tank, as described, for example, in our aforementioned US patent. At this blending stage the pH of the solution is adjusted and mixed with additives to produce Type 1 aircraft de-icing glycol solution which is stored in one or more dispensing tanks 61 ready to be transported to the regional airports 20,20′. A dispensing valve 61 is secured to the outlet 62 of the dispensing tank(s) 61 and a flow meter 63 feeds volume indicating signals to the controller 50 for association with the regional airport for processing. The holding tank 21 is also provided with a second outlet conduit 51 provided with a valve 52 and flow meter 53 to dispense the unblended 99.5% propylene glycol solution 65 in the tank 21 to some of the regional airports who wish to do their own blending and the flow data from the flow meter 53 is sent to the computer 50 for storage in its memory together with the regional airport identification code. The glycol treatment system 17 of the present invention is fully automated and can be monitored and controlled externally of the facility by a remote controller 64 via an internet link 66. It is pointed out that the illustrated schematic and block diagram of FIGS. 2 and 3, are simplified illustrations and the process includes many additional hardware, sensors and controls as illustrated in the aforementioned US Patent Therefore, the system illustrated and described herein is not intended to be limiting to the present invention.

Many other modifications and other embodiments of the present invention as described above will come to mind to a person skilled in the art to which the invention pertains having the benefit of the teachings of the embodiment described herein above and the drawings. Hence, it is to be understood that the embodiments of the present invention are not to be limited to the specific examples thereof as described herein and other embodiments are intended to be included within the scope of the present invention and the appended claims. Although the foregoing descriptions and associated drawings describe example embodiments in the context of certain examples of the elements and members and/or functions, it should be understood that different combinations of elements or substitutes and/or functions may be provided by different embodiments without departing from the scope of the present invention as defined by the appended claims. Furthermore, although specific terms are employed herein, they are used in a generic and descriptive sense only and other equivalent terms are contemplated herein with respect to the items that they relate to. It is therefore within the ambit of the resent invention to encompass all obvious modifications of the examples of the preferred embodiment described herein provide such modifications fall within the scope of the appended claims.

1. A business method including a spent glycol fluid treatment system to recover glycol from spent glycol aircraft de-icing solution from tow or more airports and providing financial benefits to airports and airlines and in the process reducing environmental pollution and waste, said method comprising the steps of:
a) providing a spent glycol servicing facility at a major airport, said servicing facility having a treatment system for the treatment of said spent glycol aircraft de-icing solutions recovered from the tarmac of said major airport and stored in a storage feed tank having sufficient capacity to store spent glycol aircraft de-icing solutions collected during a winter period, a regional storage tank for the storage of said spent glycol aircraft de-icing solutions collected from a group of regional airports associated with said servicing facility for recovering glycol from their spent glycol solutions recovered from their tarmacs, said servicing facility further having one or more supply storage thanks for the storage of substantially virgin glycol recovered by said spent glycol treatment system to supply the needs of said major airport and said group of regional airports, said step (a) providing to said major and group of regional airports:
i) a cost reduction by discontinuing or reducing the transport of their spent glycol fluid solutions to water treatment facilities where there is no financial benefit to them for the recovered glycol from their spent glycol solutions,
ii) a reliable supply of aircraft de-icing glycol fluid solution for said winter period de-icing operations and at reduced cost due to the recycling and recovery of substantially virgin glycol from their spent glycol solutions,
iii) cost saving to said group of airports and airlines having their aircrafts de-iced by aircraft de-icing solutions including said recovered substantially virgin glycol, and
iv) a benefit to the environment by the reduction of air and ground pollution produced by their previous method of recovery and storage of spent glycol solutions from their tarmac,
b) treating said spent propylene glycol fluid solution in said storage feed tank and said regional storage tank by said treatment system to remove water and other impurities to produce said substantially virgin glycol, and
c) storing said substantially virgin glycol in one or more of said one or more supply storage tanks.

2. The method as claimed in claim 1 wherein said step (a) further provides to said major and group of regional airports a reliable source for the storage of spent glycol fluid solutions from their spent glycol storage reservoir to assure continuous capacity in their spent glycol storage reservoir for the storage of their recovered spent glycol solutions, and a further benefit to the environment by the use of wastewater recovered from the spent glycol aircraft de-icing solution.

3. The method as claimed in claim 1 wherein after said step (c) there is provided the further steps of
d) blending said substantially virgin glycol from said one or more of said supply storage reservoirs with additives to produce certified glycol for use by aircraft de-icing vehicles, and
e) supplying said certified blended propylene glycol to holding tanks of said several airports in quantities commensurate with their individual needs to ensure continuous availability during winter months.

4. The method as claimed in claim 3 wherein said spent glycol solutions collected in said storage feed tank has a glycol concentration as low as about 0.25%.

5. The method as claimed in claim 4 wherein said spent glycol solutions collected in said regional storage tank has a glycol concentration of at least 10% glycol.

6. The method as claimed in claim 5 wherein said spent glycol treatment system is operational on a continuous basis for the treatment of spent glycol solutions contained in said storage feed tank and said regional storage tank to ensure adequate space therein to receive spent glycol solutions from said major airport and said group of regional airports as well as ensuring adequate certified glycol in said supply storage tank to service all of the needs of said major and regional airports.

7. The method as claimed in claim 3 wherein said spent glycol solutions contain large quantities of water, propylene glycol and other residues collected from the tarmac of said major and group of reginal airports, said spent glycol treatment system having an evaporator stage for treating said spent glycol contained in said storage feed tank to elevate the concentration of the glycol therein to substantially 10% and recovering water therefrom for re-use by said major airport for grey water applications.

8. The method as claimed in claim 1 wherein there is further provided the step of transferring know-how to said group of airports regarding effective methods for the recovery of spent glycol aircraft de-icing solutions from their tarmacs which contain glycol concentrations of at least 10%, and as well, local storage and delivery of the recovered spent glycol solutions to said servicing facility, said know-how further including means for reduction of the air and ground pollution caused by their method of recovery and storage of their recovered spent glycol aircraft de-icing solutions from their tarmacs.

9. The method as claimed in claim 1 wherein said method further comprises the step of (e) establishing a data communication link between said servicing facility and said major airport and said group of airports, said data communication link including limiting access to personalized information contained in a computer system having a memory in which is stored a program to provide storage of said personalized information of said major and individual ones of said regional airports, such as, volumes of delivered spent glycol solutions delivered to said facility, certified blended glycol delivered to said major and regional airports, and several other related business transaction information data.

10. The method as claimed in claim 4 wherein said step (b) further comprises (i) feeding said collected spent glycol solutions stored in said storage feed tank to a low-concentration evaporator which refines said spent glycol solutions from about 0.25% to a concentration of at least a 10% glycol concentration, and (ii) feeding said spent glycol solutions of at least 10% glycol concentration to said regional storage tank.

11. The method as claimed in claim 10 wherein there is further provided the steps of (iii) feeding said spent glycol solutions in said regional storage tank to an ultrafiltration stage to remove solids from said spent glycol solutions, and (iv) subjecting said filtered refined spent glycol solution to a further evaporator where the remaining spent glycol solution contains about 50% glycol, and further subjecting said remaining spent glycol solution to separate the remaining water to obtain a glycol fluid solution containing about 99.5% substantially virgin glycol which is stored in said one or more supply storage tank.

12. The method as claimed in claim 11 wherein after said step (iii) and before said step (iv) there is provided the step of feeding said filtered refined spent glycol solutions to a buffer tank to accumulate said filtered refined spent glycol solution awaiting a batch transfer to said filtered refined spent glycol solution to said evaporator and ensuring continuous operation of said treatment system.

13. The method as claimed in claim 10 wherein there is further provided the step of recovering water from at least said low concentration evaporator in a grey water tank for use by said major airport in their grey water system resulting in water conservation from a potable water supply.

14. The method as claimed in claim 3 wherein said major airport is an international airport where there is a large requirement for the treatment of spent glycol aircraft de-icing solutions due to a high volume of air traffic.

15. A spent glycol treatment method, associated with a business method and a spent glycol servicing facility which provides cost benefits to airports and airlines and reduces environmental pollution and waste, said method comprising the steps of:
i) storing in a storage feed tank of said servicing facility spent glycol aircraft de-icing solutions recovered from the tarmac of a major airport at which said spent glycol servicing facility is operational,
ii) storing in a regional storage tank of said servicing facility spent glycol solutions received from a group of regional airports located in a servicing geographical area to said spent glycol servicing facility,
iii) feeding said spent glycol aircraft de-icing solution from said storage feed tank to a low-concentration evaporator which refines said spent glycol solution by evaporating water to elevate the glycol concentration of from about 0.25% to about 10% glycol concentration,
iv) feeding said spent glycol solution having a glycol concentration of about 10% glycol concentration to said regional storage tank,
v) filtering said spent glycol solution having a glycol concentration of about 10% glycol concentration to remove thickeners and residues,
vi) feeding said filtered spent glycol solution having a glycol concentration of about 10% glycol concentration to a further evaporator to further remove water from said spent glycol solution having a glycol concentration of about 10% glycol concentration to bring the glycol therein to a concentration of substantially 50% glycol,
vii) feeding said glycol of a concentration of substantially 50% glycol to a distiller wherein said remaining water therein is separated from said glycol to produce substantially virgin glycol of a concentration of about 99.5% which is substantially virgin glycol, and
viii) storing said substantially virgin glycol of a concentration of about 99.5% in a supply storage tank for further use in producing certified aircraft de-icing glycol fluid solutions.

16. The high efficiency spent glycol treatment method as claimed in claim 15 wherein after said step (vi) and before sid step (vii) there is provided the step of feeding said substantially virgin glycol of a concentration of about 99.5% to a distiller feed tank wherein said glycol is recirculated through further filtration and wherein the pH of the glycol is adjusted.

17. The high efficiency spent propylene glycol treatment method as claimed in claim 15 wherein there is further provided the step of condensing and collecting in a grey water storage tank water evaporated from at least one of said evaporators and said distiller for further use by said major airport, and further wherein after said step (vii) there is provided the further step of blending said substantially virgin glycol of a concentration of about 99.5% with additives to produce AMS 1424 certified Type 1 aircraft de-icing glycol solutions for use in de-icing aircrafts.

18. The high efficiency spent glycol treatment method as claimed in claim 15 wherein said step (ii) further comprise (a) measuring by the use of a refractometer the glycol concentration in the spent solution received from the regional airports and (b) redirecting the solution to said storage feed tank if the glycol concentration is below 10%.

19. The high efficiency spent glycol treatment method as claimed in claim 18 wherein said step (ii) further comprises (a) measuring the volume, by the use of a flow meter, of said spent glycol solutions of each of said regional airports as it is being stored in said regional storage tank or said storage feed tank, (b) recoding the measured volumes in a data bank of a computer in association with and identification of each said regional airports.

20. A spent glycol treatment system of a servicing facility, to carry out the business method of claim 15, for the recovery of glycol from spent glycol solutions recovered from the tarmac of a major airport at which said treatment system is operative, said spent glycol treatment system having a storage feed tank in which is stored spent glycol recovered from said tarmac of said major airport, a regional storage tank in which is stored spent glycol solutions received from a group of regional airports, a supply storage tank for the storage of aircraft de-icing glycol fluid solution recovered from said spent glycol by said spent glycol treatment system, a low concentration evaporator for refining said spent glycol solutions contained in said storage feed tank to elevate the glycol concentration of from about 0.25% to at least 10% glycol concentration for mixing with said spent glycol solutions collected in said regional storage tank, a filtration stage for filtering said spent glycol solution from said regional storage tank containing said glycol concentration of at least 10% to remove thickeners and residues therein, a further evaporator to remove water from the filtered liquid having a glycol concentration of about 10% to further remove water to bring the glycol to a concentration of substantially 50% in the remaining liquid, a distiller for separating the 50% water above the glycol concentration of substantially 50% to produce glycol having a concentration of substantially 99.5%, and one or more storage tanks for the storage of said glycol having a concentration of substantially 99.5%.

21. The spent glycol treatment system as claimed in claim 20 wherein there is further provided a blending tank in which is fed a predetermined volume of said glycol having a concentration of substantially 99.5% concentration for blending with additives to produce MMS 1424 certified Type 1 aircraft de-icing glycol solutions.

22. The spent glycol treatment system as claimed in calin 21 wherein there is further provided a waste grey water storage tank for the storage of water evaporated from at least one of said evaporators and said distiller for further use by said major airport and thereby resulting in a reduction of water demands from the public water supply and thereby conserving potable water.
